(19) United States
(12) Patent Application Publication
(10) Pub. No.: US 2022/0321052 A1
(43) Pub. Date: Oct. 6, 2022

(54) ELECTRICAL-POWER GENERATING MODULE

(71) Applicant: ACPV, Paris (FR)

(72) Inventors: André SASSI, Rueil Malmaison (FR); Jocelyne SASSI, Rueil Malmaison (FR)

(73) Assignee: ACPV, Paris (FR)

(21) Appl. No.: 17/597,052

(22) PCT Filed: Oct. 21, 2019
(86) PCT No.: PCT/FR2019/052492

§ 371 Date: Jan. 21, 2022

(30) Foreign Application Priority Data
Jun. 25, 2019 (FR) FR1906875

(51) Int. Cl. H02S 10/12; H02S 10/20; H02S 20/10; H02S 30/20; H02S 40/10; B60L 53/31

(52) U.S. Cl. CPC H02S 10/12; H02S 10/20; H02S 20/10; H02S 30/20; H02S 40/10; B60L 53/31

(57) ABSTRACT

Electrical-power generating module, characterised in that it comprises at least one wind turbine (E) having blades (E1) forming blade tips (E11) and at least one photovoltaic surface (P) comprising an undulating rigid structure (S) covered with flexible photovoltaic panels (F), the wind turbine (E) being disposed above the flexible photovoltaic panels (F) with the blade tips (E11) passing close to the flexible photovoltaic panels (F) in order to deter birds and clean the flexible photovoltaic panels (F).

The present invention relates to an electrical-power generating module that combines at least two different energy sources, namely wind and sun. Thus, the electrical-power generating module of the invention comprises both photovoltaic sensors and one or more wind turbines.

On the one hand, there are already flat and rigid photovoltaic panels that can be installed on roofs or structures provided for this purpose, as in solar farms.

In addition, there are also wind turbines, such as large wind turbines mounted on large masts and installed in the open countryside.

In general, photovoltaic panels and wind turbines are not installed in urban areas. In addition, they are implemented either on an individual scale (house) or on an industrial scale (solar farms or wind farms): the intermediate scale has been neglected and hardly exists or does not exist.

The present invention relates specifically to an implementation on an intermediate scale, more particularly adapted to an urban environment or to an agricultural operation.

To do this, the present invention combines undulating photovoltaic panels and wind turbines, but with a particularly advantageous relative arrangement, namely that the wind turbine(s) is arranged close to and above the photovoltaic panels. In other words, the wind turbines overhang the photovoltaic panels from above. This particular relative arrangement provides several advantages. Firstly, the wind turbines keep birds away, so that they do not dump their excrement on the photovoltaic panels. The birds will also not nest on or in the electrical-power generating module, as they are deterred by the wind turbines. This is particularly true in the city, where large colonies of pigeons live. Secondly, the wind turbines will permanently clean the photovoltaic panels by the airflow that they create: this prevents dust and leaves (or any other light particles) from accumulating on the photovoltaic panels. Thirdly, when photovoltaic panels are cleaned with water or when it rains on them, the wind turbines drive the water away from the photovoltaic panels, which contributes to their cleanliness. The blade tips of the wind turbines may pass within one meter of the photovoltaic panels, or within 50 cm, advantageously within 20 cm or even within 10 cm.

Thus, the electrical-power generating module of the invention comprises at least one wind turbine having blades forming blade tips and at least one photovoltaic surface comprising a undulating rigid structure covered with flexible photovoltaic panels, the wind turbine being disposed above the flexible photovoltaic panels with the blade tips passing close to the flexible photovoltaic panels to deter birds and clean the flexible photovoltaic panels.

According to a particularly advantageous characteristic, the photovoltaic surface forms low concave zones and high convex zones, the wind turbines being disposed at the level of the low concave zones. Thus, the photovoltaic surface follows the trajectory of the blade tips of the wind turbines over a certain angle, for example about 30° to 90°.

In a practical embodiment, the photovoltaic surface is constituted by an assembly of undulating base elements comprising an undulating rigid structure covered with flexible photovoltaic panels. Advantageously, the undulating base elements are identical and stackable. Preferably, each undulating base element results from the joining of parallel cylinder segments or straight lines. A desired extent of photovoltaic panels can thus be constructed simply by assembling identical base elements, like a roof covering formed of nested tiles. The dimensions of these base elements may be about 1 to 2 metres per side, that is a surface area of about 1 to 4 m². The aim is that the base elements can be handled and installed by one single person. Their weight must not exceed 5 to 15 kg.

According to another aspect of the invention, the wind turbine may be mounted on a mast comprising a crosspiece that supports the undulating base elements. In practice, each electrical-power generating module will generally comprise several masts, as many wind turbines and one or two photovoltaic surfaces disposed on the crosspieces of the masts. Thus, the masts constitute the base support elements on which the wind turbines and the photovoltaic surfaces composed of undulating base elements are mounted. Advantageously, the undulating base elements are secured to crosspieces at low connection points and join in the form of an arch at high connection points. Advantageously, sprinklers are provided on the mast to clean the photovoltaic panels. The wind turbines will contribute to the drying of the photovoltaic panels after each spraying.

The module may also comprise an electrical storage unit for storing at least some of the electricity from the flexible photovoltaic panels and the at least one wind turbine. Advantageously, the module can be connected to the electrical grid, and in this case, said at least one wind turbine, in the absence of wind, is supplied with current by the electrical storage unit or the electrical grid, such that it rotates continuously. This ensures that the “scarecrow” and cleaning functions are permanent.

In an urban version, the module may also comprise at least one electrical charging terminal for charging rechargeable electric vehicles, the electrical charging terminal being advantageously mounted on the mast, below the photovoltaic panels.

In a mobile version more suitable for an agricultural operation, the module may comprise at least one anchoring base on which the mast is removably mounted. Advantageously, the rigid structure and the mast are made of lightweight and/or recyclable composite materials. Thus, a farmer may rent or purchase one or more power-generating modules and install them as it pleases on parcels he does not cultivate. He will be able to move them easily because of their small size and their lightness. The wind turbines and the base elements can be removed from the masts to facilitate handling, or, on the contrary, the masts with their wind turbines and rigid structures can be handled in one single piece, without the need for lifting equipment.

The scope of the invention resides in the fact that the wind turbine(s) act(s) as a “scarecrow” (mainly for pigeons in the city and starlings in the countryside), as a dust collector and as a dryer, in order to protect the photovoltaic panels and to keep them clean. The use of flexible photovoltaic panels or films mounted on undulating rigid structures makes it possible to create profiled surfaces, which are optimised with respect to the sun and/or the wind turbines. The use of one (or more) central support mast(s) to support the wind turbine, sprinklers and a charging terminal is a particularly advantageous characteristic.

The invention will now be described more fully below, with reference to the accompanying drawings which show two embodiments of the invention by way of non-limiting examples.

In the Figures:

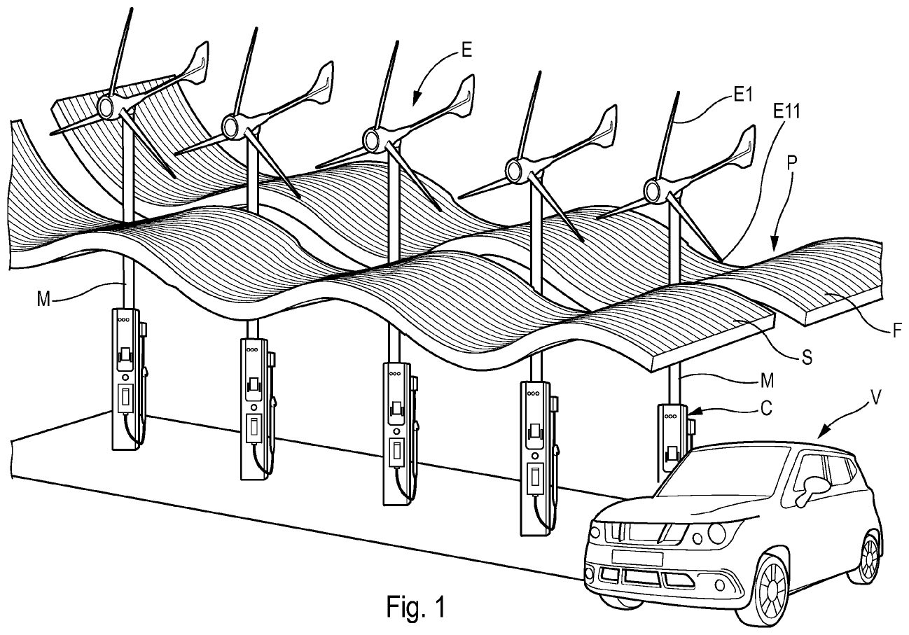

FIG. 1 is a perspective view of an electrical-power generating module in the form of an electric vehicle charging station,

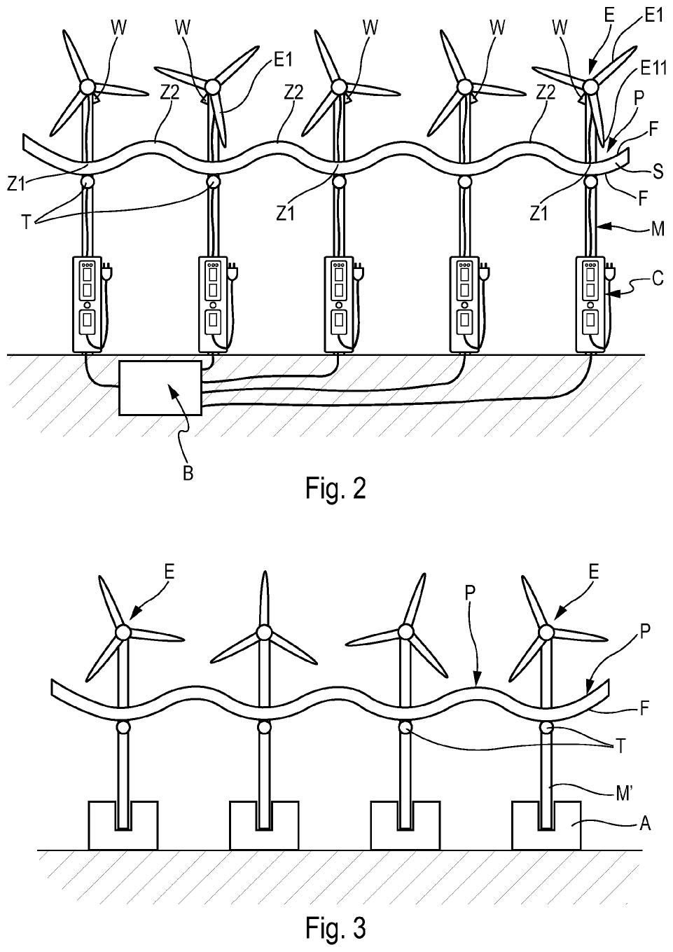

FIG. 2 is a schematic front and cross-sectional view of the electric vehicle charging station of FIG. 1,

FIG. 3 is a schematic front and cross-sectional view of a mobile electrical-power generating module, in particular for use on agricultural operations, and

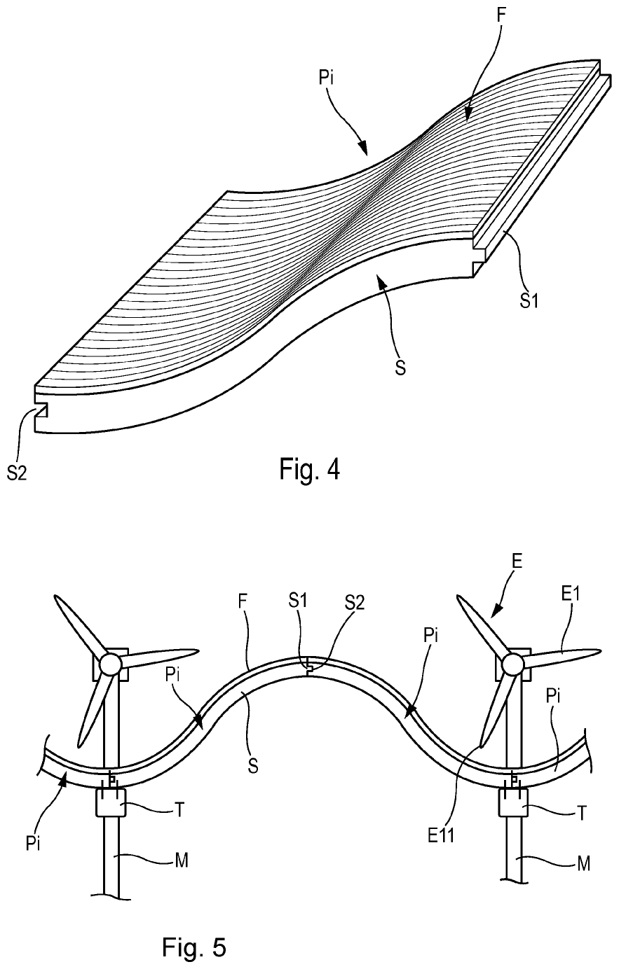

FIG. 4 is a schematic, perspective view of an undulating base element of the invention,

FIG. 5 is a plan view showing the implementation of the undulating base elements of FIG. 4 in an electrical-power generating module according to the invention,

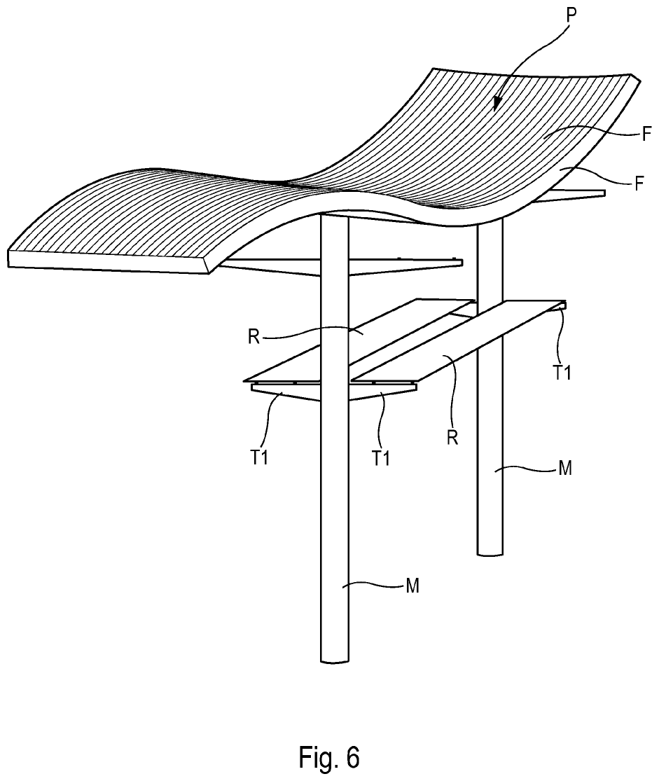

FIG. 6 is a schematic plan view of an electrical-power generating module according to an embodiment variant.

Reference is made firstly to FIG. 1 in order to describe in detail an electrical-power generating module of the invention which is in the form of an electric charging station for an electric vehicle. Consequently, this electrical-power generating module is more for urban use (large cities, large towns, medium-sized towns, small towns, villages).

In FIG. 1, it can be seen that the electric vehicle charging station comprises five wind turbines E and two photovoltaic surfaces P. This charging station can be installed both in the city and in the countryside, in particular to deal with the problem of the isolation of the territories and to distribute the electric cars evenly. The wind turbines E are installed at the top of masts M which are anchored in the ground. These masts M also serve as supports for the two photovoltaic surfaces P. The masts M also serve as supports for charging terminals C which are installed close to the ground or at ground level. The user of an electric vehicle V can thus charge the battery of their vehicle at one of the charging terminals C. When the electrical-power generating module is installed along a pavement, it can also be used for charging push scooters, bicycles, motor scooters and hoverboards.

The wind turbines E each comprise three blades E1, which are intended to be rotated by wind. The wind turbines E are mobile in rotation on their respective mast M, so as to adapt to the direction of the wind. The wind turbines E are of average size, and are advantageously extremely silent. The length of the blades E1 advantageously does not exceed 0.5 metres.

In FIG. 1, it can be noted that the wind turbines E are disposed above the surfaces P at a distance of 1 to 2 metres. The tip E11 of the blades E1 can pass within 20 centimetres of the surfaces P. Thus, by rotating, the blades E1 of the wind turbines E create airflows that will sweep the upper surface of the photovoltaic surfaces P. These airflows will thus remove any object (leaves or dust) from the surfaces P that would be deposited therein. The airflows also repel rain or cleaning water which could stagnate on the photovoltaic surfaces P. On the other hand, the wind turbines E act as a “scarecrow” for the birds which thus remain away from the photovoltaic surfaces P. The wind turbines E thus fulfil a threefold function of protection, sweeping and drying for the photovoltaic surfaces P, simply being disposed close to and above the surfaces.

It can be seen in FIG. 1 that the electrical charging station here comprises two photovoltaic surfaces P. The surfaces P are profiled, in particular undulating. Each surface P comprises a support structure S which is rigid and undulating. For example, the support structure S may be made from extremely lightweight composite materials.

It may be noted that the undulation of the support structure S is not random, but results from the joining of parallel cylinder segments or straight lines.

Photovoltaic sensors are disposed on the support structure S according to its profiled shape. Advantageously, the photovoltaic sensors are in the form of a semi-flexible or flexible and thin photovoltaic film or panel that will closely match the profiled shape of the support structure S. The photovoltaic film may be of the polymer-based organic type, such as that commercialised by the company ARMOR under the trademark ASCA®. The semi-flexible photovoltaic panel may be that commercialised by the company SunPower®. The photovoltaic film or panel F covers the upper face of the support structures S, but can also cover the lower face, as well as the side edges. Indeed, this photovoltaic film or panel F is particularly sensitive to light, and this light also reaches the lower face of the support structure S. It is thus possible to design photovoltaic surfaces P comprising a support structure S entirely coated with the photovoltaic film or panel F. It is also possible to choose the colour of the photovoltaic film according to the installation location: for example, green in the countryside, another colour of choice for cities and a sand colour for barren or desert areas.

FIG. 2 shows the electrical charging station of FIG. 1 from another angle and partially cross-sectional. It can be seen that the photovoltaic panels P are supported by horizontal crosspieces T fixed to the masts M. The panels P can be fixed by any appropriate technical means to the horizontal crosspieces T. It can also be noted that the photovoltaic panels P are undulating so as to form low concave zones Z1 and high convex zones Z2, alternately and consecutively. The panels P are mounted on the horizontal crosspieces T at the low concave zones Z1, such that the tips of the blades E1 of the wind turbines E follow the low concave zones with a substantially constant spacing. It may also be said that the low concave zones follow the trajectory of the tips of the blades E1 over a certain angle, for example about 30° to 90°. This makes it possible to bring the tips of the blades E1 of the photovoltaic panels P as close as possible, with the aim of further improving their protective and cleaning function.

The electrical charging station in FIGS. 1 and 2 of course comprises all the equipment necessary to be able to inject the electricity produced into the domestic grid. In particular, this equipment may comprise one or more inverters. The station may also comprise an electrical storage unit B, which may be in the form of an accumulator or battery, thus making it possible to store a portion of the electricity produced, in particular in order to power the charging terminals and the motors making it possible to pivot the wind turbines E. The electrical storage unit B may also control sprinklers or cleaning nozzles W, for example installed on the masts M close to their upper end, as can be seen in FIG. 2. Thus, the photovoltaic surfaces P can be cleaned automatically using these sprinklers W, and then dried by the wind turbines E. Thus, a completely autonomous electrical charging station is had, both in terms of electricity and in terms of cleaning means for the photovoltaic surfaces P. Of course, the charging terminals C can also be supplied with mains electricity, in particular when the electrical-power generation from the wind turbines and from the photovoltaic surfaces is insufficient.

The wind turbines of the invention are not only used to generate electricity, but also to deter birds and clean photovoltaic panels. It is therefore advantageous for them to rotate continuously, or at least the vast majority of the time. For this, it is wise to supply them with electricity, from the electrical storage unit B or from the grid, when there is not enough wind. Given that the storage unit B is charged by the wind turbines E (and the surfaces P), it can be said that the wind turbines are self-powered.

With reference to FIG. 3, another electrical generating module of the invention can be seen in the form of a mini-solar and wind power plant, which can easily be moved. It can easily be installed on farms, but also in gardens, private parks, etc.

The major difference with the first embodiment resides in the fact that the masts M′, which support the wind turbines E and the photovoltaic surfaces P, are not sealed in the ground, but removably engaged in anchoring bases A which rest on the ground. The masts M′ are here devoid of charging terminals C and the photovoltaic surfaces P may be arranged a little closer to the ground. This mini-solar and wind power plant has the advantage of being easily movable, given that the masts M′ are removably engaged in the anchoring bases A, which are also mobile. Thus, a user, such as a farmer, can move the mini-power plant on fallow land as desired. The photovoltaic surfaces P can be disassembled from their horizontal crosspieces T, or not. The wind turbines E may or may not be disassembled from their masts M′. The user can thus disassemble the electrical-power generating module, move the anchoring bases A and reassemble the module. In a variant, the module may remain in the mounted state and be moved in one single piece. The lightness of the module does not justify the use of lifting means.

By way of indication, each photovoltaic surface P may have a length of 20 m and a width of about 1 to 2 metres. Due to the rigid structure S is undulating, the useful length of the surfaces P is about 25 metres. Thus, each energy-power generating module has a useful photovoltaic surface area of about 50 to 100 m². As for the weight of each surface, it may be about 50 kg.

The photovoltaic surfaces P can each be designed as one piece, with a one-piece support structure S that is covered with photovoltaic film or panel F. In a variant, each photovoltaic surface P can result from the assembly of undulating base elements Pi of reduced dimensions, for example by 1 metre by 2 metres, as shown in FIG. 4. All of the undulating base elements Pi are preferably identical, and in addition they can be stacked. Their undulation also results from the joining of parallel cylinder segments or straight lines. Each undulating base element Pi comprises an undulating rigid structure S which is coated with a photovoltaic film or panel F, in the same way as the photovoltaic surfaces P.

The base elements Pi may be assembled simply by nesting together to form a photovoltaic surface P of desired dimensions. For this, each base element Pi defines two opposite straight edges which are provided with male and female rebates S1 and S2 formed by the undulating rigid structure S. As shown in FIG. 5, the base elements Pi nest into each other at low connection points and at high connection points. It can be noted that the low connection points are positioned at the crosspieces T on which the base elements Pi can be fixed, for example by screwing. The high connection points are not supported, but they form self-supporting arches.

It can be considered to use the base elements Pi instead of tiles to form a roof covering.

Still in this scope of lightness and modularity, the masts M, M′ may consist of nestable segments of reduced length, for example from 1 to 2 metres.

In FIG. 6, it can be seen that the electrical-power generating module of the invention may also be provided with reflective plates R which are disposed below the photovoltaic panels P to reflect light on the lower face of the panels, which are then covered with photovoltaic films or panels F. These reflective plates R may be supported by secondary crosspieces T1 mounted on the masts M. These plates R may be made of glass, metal, or any other material capable of reflecting light. It is thus possible to optimise the efficiency of the photovoltaic surfaces P.

According to the installation location of the electrical-power generating module, wind barriers may be installed to reduce the module's wind speed.

The invention thus provides a medium-sized electrical-power generating module that can be installed in an urban environment as well as on agricultural areas. The synergistic combination of wind turbines and undulating photovoltaic surfaces allows maximum protection and easy maintenance of the photovoltaic surfaces. In addition, the low weight of the various elements and their small size and the particularly simple fitting and assembly method allow the installation of the electrical-power generating module by one single person, who does not require professional skills.

1. Electrical-power generating module, characterised in that it comprises at least one wind turbine (E) having blades (E1) forming blade tips (E11) and at least one photovoltaic surface (P) comprising an undulating rigid structure (S) covered with flexible photovoltaic panels (F), the wind turbine (E) being disposed above the flexible photovoltaic panels (F) with the blade tips (E11) passing close to the flexible photovoltaic panels (F) in order to deter birds and clean the flexible photovoltaic panels (F).

2. Module according to claim 1, wherein the blade tip (E11) passes within 50 cm, advantageously within 20 cm, or even within 10 cm, of the flexible photovoltaic panels (F).

3. Module according to claim 1, wherein the photovoltaic surface (P) forms low concave zones (Z1) and high convex zones (Z2), the wind turbines (E) being disposed at the low concave zones (Z1).

4. Module according to claim 1, wherein the photovoltaic surface (P) consists of an assembly of undulating base elements (Pi) comprising an undulating rigid structure (S) covered with flexible photovoltaic panels (F).

5. Module according to claim 4, wherein the undulating base elements (Pi) are identical and stackable.

6. Module according to claim 4, wherein each undulating base element (Pi) results from the joining of parallel cylinder segments or straight lines.

7. Module according to claim 1, wherein the wind turbine (E) is mounted on a mast (M; M′) comprising a crosspiece which supports the undulating base elements (Pi).

8. Module according to claim 7, wherein the undulating base elements (Pi) are secured with crosspieces (T) at low connection points and meet in the form of an arch at high connection points.

9. Module according to claim 7, wherein sprinklers (W) are provided on the mast (M; M′) for cleaning the flexible photovoltaic panels (F).

10. Module according to claim 1, comprising an electrical storage unit (B) for storing at least some of the electricity from the flexible photovoltaic panels (F) and from said at least one wind turbine (E).

11. Module according to claim 10, connected to the electrical grid, wherein said at least one wind turbine (E), in the absence of wind, is supplied with current by the electrical storage unit (B) or the electrical grid, such that it rotates continuously.

12. Module according to claim 1, comprising at least one electrical charging terminal (C) for charging rechargeable electric vehicles (V), the electrical charging terminal (C) being installed below the photovoltaic panels.

13. Module according to claim 7, wherein the electrical charging terminal (C) is mounted on the mast (M).

14. Module according to claim 1, comprising at least one anchor base (A) on which the mast (M′) is removably mounted.

15. Module according to claim 1, wherein the rigid structure (S) and the mast (M: M′) are made of lightweight and recyclable composite materials.
